(19) United States
(12) Patent Application Publication
(10) Pub. No.: US 2012/0208492 A1
(43) Pub. Date: Aug. 16, 2012

(54) Emergency Message Generation and Transmission

(76) Inventors: Hannes Tschofenig, Espoo (FI); Deh-Min Richard Wu, Boynton Beach, FL (US)

(21) Appl. No.: 13/502,877

(22) PCT Filed: Oct. 19, 2009
(86) PCT No.: PCT/EP09/63665

§ 371 Date: Apr. 19, 2012

(51) Int. Cl. H04W 4/22

(52) U.S. Cl. 455/404.2

(57) ABSTRACT

There is proposed a mechanism by means of which an emergency message is generated in a movable object, such as a vehicle, and transmitted to an emergency recipient. Specific information comprising location information of the movable object is determined and processed so as to form an additional information portion for an emergency message based on a data format of an emergency alerting and warning protocol, such as Common Alerting Protocol (CAP). The thus created emergency message is immediately sent to a recipient in case an emergency event is detected. On the recipient side, the location information are retrieved from the emergency message and processed for providing additional information allowing an improved reaction on the emergency.

The present invention relates to a mechanism for generating and transmitting an emergency message related to a movable object, such as a vehicle. Specifically, the present invention relates to a mechanism for generating and transmitting an emergency message based on a data format of an emergency alerting and warning protocol, such as the Common Alerting Protocol (CAP) wherein the emergency message recipient can be provided with additional information.

### RELATED PRIOR ART

Emergency calls made from vehicles can assist with the objective of significantly reducing road deaths and injuries. The simplest form of an emergency call is an establishment of a commonly known communication connection, such as a speech call, by means of vehicle-mounted or personal communication equipment, such as cellular telephones or telecommunication device.

For enabling assistance in case of an emergency, due to the originally unknown location of a movable or mobile object from which the emergency call is sent, it is in particular necessary to obtain information regarding the position of the vehicle or the like. Unfortunately, drivers often have a poor location-awareness, especially on urban roads (also during night) and abroad. In the most crucial cases, the victim(s) may not be able to call or trigger the emergency call, for example because they have been injured or trapped.

Therefore, in order to increase safety and speed up possible reactions on a vehicle crash or the like, for example the information of a corresponding emergency call recipient like the police or the fire department, it is contemplated to automate emergency calls. In Europe, for example, the European Commission has launched the eCall initiative that may best be described as a user initiated or automatically triggered system to provide notifications to specific receivers, i.e. so-called Public Safety Answering Points (PSAP), that a vehicle has crashed, and also to provide geodetic location information. The communication may be done by means of cellular communications, for example it is defined to work with circuit switched telephony.

Providing the features for IP-based environments has already been started due to the increased deployment of IP (Internet Protocol) networks. With regard to the transmission of IP-base emergency calls, there has been proposed, for example, a mechanism which enables a functionality allowing a regular emergency call to be triggered by the car which means that a voice channel is established between the occupant(s) of a crashed vehicle and an emergency call recipient.

A further consideration regarding a transmission of information emergency information is to use specific emergency alerting and warning protocols, for example the so-called CAP being specified, for example, in OASIS (Organization for the Advancement of Structured Information Standards) Standard CAP-V1.1, October 2005. Emergency alerting and warning protocol formats may provide a template for warning or emergency messages. For example, CAP is a simple but general format (based on eXtensible Markup Language, XML) for exchanging all-hazard emergency alerts and public warnings over all kinds of networks. CAP allows a consistent warning message to be disseminated simultaneously over many different warning systems, and also facilitates the detection of emerging patterns in local warnings of various kinds.

An implementation of emergency message transmission systems in movable objects, like vehicles, involves several problems. For example, equipping vehicles with functionality to allow voice communication to take place is costly. Furthermore, information regarding the emergency such as position information or information allowing to derive some background information to comprehend the kind of emergency have to be sent to the emergency call recipient or an emergency services network in a reliable and quick manner for allowing a suitable response.

### SUMMARY OF THE INVENTION

Thus, it is an object of the invention to provide an improved mechanism for generating and transmitting an emergency message related to a movable object, such as a vehicle. Specifically, it is an object of the invention to provide methods and apparatuses capable of generating and transmitting an emergency message based on a data format of an emergency alerting and warning protocol, such as the Common Alerting Protocol (CAP), wherein the emergency message recipient can be provided with additional information regarding the emergency.

These objects are achieved by the measures defined in the attached claims.

According to an example of the proposed solution, there is provided, for example, a method comprising determining location information of a movable object, processing the location information for creating a condition data set based on the location information, storing the condition data set, generating an emergency message based on a data format of an emergency alerting and warning protocol, the emergency message comprises a portion including the condition data set, and sending the emergency message to a recipient in case an emergency event is detected.

In addition, according to an example of the proposed solution, there is provided, for example, an apparatus comprising a determiner configured to determine location information of a movable object, a processor configured to process the location information for creating a condition data set based on the location information, a memory configured to store the condition data set, a message generator configured to generate an emergency message based on a data format of an emergency alerting and warning protocol, the emergency message comprises a portion including the condition data set, and a sender configured to send the emergency message to a recipient in case an emergency event is detected.

According to further refinements, the above examples may comprise one or more of the following features:
the location information may comprise at least one of position information, velocity information, acceleration information, and orientation information of the movable object at a specific timing;
the condition data set may comprise information identifying a type of the movable object;
the processing of the location information may comprise a calculation of at least one average value of a plurality of location information determined at different timings, wherein the condition data set may comprise the calculated at least one average value;
the processing of the location information may comprise collecting of consecutive sets of location information determined at different timings, wherein the condition data set may comprise the individual sets of location information determined at different timings; then, the condition data set may comprise sets of location information determined within a predefined interval of time, the interval of time may start from the timing the newest set of location information being determined;
the emergency alerting and warning protocol may be based on at least one of the common alerting protocol, wherein the generation of the emergency message may comprise attaching the condition data set as a payload to a message portion based on the common alerting protocol format, or a GeoRSS based protocol, wherein the generation of the emergency message may comprise attaching the condition data set to a message based on GeoRSS format;
the sending of the emergency message to the recipient may be executed automatically and immediately when an emergency event of the movable object is detected;
the sending of the emergency message to the recipient may be done via a communication network, wherein the emergency message may be transmitted to a network element of the communication network by using a data transmission protocol;
a check of a connectivity value of a communication link for sending the emergency message may be executed, and the portion including the condition data set of the emergency message may be adjusted on the basis of the connectivity value of the communication link.

According to a further example of the proposed solution, there is provided, for example, a method comprising receiving an emergency message based on a data format of an emergency alerting and warning protocol from a movable object, processing the emergency message, detecting a portion in the emergency message including a condition data set comprising location information, analyzing the location information, determining a destination for forwarding the emergency message on the basis of the location information, and sending the emergency message to the determined destination.

In addition, according to a further example of the proposed solution, there is provided, for example, an apparatus comprising a receiver configured to receive an emergency message based on a data format of an emergency alerting and warning protocol from a movable object, a processor configured to process the emergency message, a detector configured to detect a portion in the emergency message including a condition data set comprising location information, an analyzer configured to analyze the location information, a determiner configured to determine a destination for forwarding the emergency message on the basis of the location information, and a sender configured to send the emergency message to the determined destination.

According to further refinements, the above examples may comprise one or more of the following features:
the location information may comprise at least one of position information, velocity information, acceleration information, and orientation information of the movable object at a specific timing;
the condition data set may comprise information identifying a type of the movable object;
the condition data set may comprise at least one an average value of a plurality of location information determined at different timings at the movable object, and a collection of consecutive sets of location information determined at different timings at the movable object;
the emergency alerting and warning protocol may be based on at least one of the common alerting protocol, wherein the condition data set may be attached to the emergency message as a payload to a message portion based on the common alerting protocol format, or a GeoRSS based protocol, wherein the condition data set may be attached to a message based on GeoRSS format;
the emergency message may be received via a communication network, wherein the emergency message may be transmitted to a network element of the communication network by using a data transmission protocol.

According to a further example of the proposed solution, there is provided, for example, a method comprising receiving an emergency message based on a data format of an emergency alerting and warning protocol originated from a movable object, processing the emergency message for preparing a reaction thereon, detecting a portion in the emergency message including a condition data set comprising location information, processing the location information contained in the condition data set for providing additional information related to the emergency, and providing to a recipient an indication regarding the emergency together with the additional information based on the location information.

In addition, according to a further example of the proposed solution, there is provided, for example, an apparatus comprising a receiver configured to receive an emergency message based on a data format of an emergency alerting and warning protocol originated from a movable object, a first processor configured to process the emergency message for preparing a reaction thereon, a detector configured to detect a portion in the emergency message including a condition data set comprising location information, a second processor configured to process the location information contained in the condition data set for providing additional information related to the emergency, and an informer configured to provide a recipient with an indication regarding the emergency together with the additional information based on the location information.

According to further refinements, the above examples may comprise one or more of the following features:
the location information may comprise at least one of position information, velocity information, acceleration information, and orientation information of the movable object at a specific timing;
the condition data set may comprise information identifying a type of the movable object, wherein the additional information further may comprise a type indication based thereon;
the condition data set may comprise at least one an average value of a plurality of location information determined at different timings at the movable object, and a collection of consecutive sets of location information determined at different timings at the movable object, wherein the additional information may reflect the respective information;
the emergency alerting and warning protocol may be based on at least one of the common alerting protocol, wherein the condition data set may be attached to the emergency message as a payload to a message portion based on the common alerting protocol format, or a GeoRSS based protocol, wherein the condition data set may be attached to a message based on GeoRSS format;
the emergency message may be received from a network element of a communication network, wherein the emergency message may be transmitted from the network element of the communication network by using a data transmission protocol.

According to a further example of the proposed solution, there is provided, for example, a method comprising generating an emergency message based on a data format of an emergency alerting and warning protocol, creating a condition data set based on location information obtained for a movable object, attaching a portion to the emergency message comprising the condition data set.

According to further refinements, the above example may comprise one or more of the following features:
the location information may comprise at least one of position information, velocity information, acceleration information, and orientation information of the movable object at a specific timing.
the condition data set may comprise information identifying a type of the movable object;
the creating of the condition data set may comprise a calculation of at least one average value of a plurality of location information determined at different timings;
the creating of the condition data set may comprise collecting of consecutive sets of location information determined at different timings, wherein the condition data set may comprise the individual sets of location information determined at different timings; then, the condition data set may comprise sets of location information determined within a predefined interval of time, the interval of time may start from the timing the newest set of location information being determined;
the emergency alerting and warning protocol may be based on at least one of the common alerting protocol, wherein the condition data set may be attached as a payload to a message portion based on the common alerting protocol format, or a GeoRSS based protocol, wherein the condition data set may be attached to a message based on GeoRSS format.

Moreover, according to another example of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide the emergency call recipient with additional information about the incident (emergency) based on information collected at the movable object (the vehicle) over a plurality of time points immediately before the emergency (like an accident). Thus, not only, for example, the last position of the movable object but possibly even an entire track of the past few minutes may be transmitted to the emergency services. Such history data may also give additional information about the emergency situation, which e.g. helps evaluating how serious the situation is or what caused the accident i.e. what happened before the alert.

Furthermore, by using emergency messaging based on an emergency alerting and warning protocol, like CAP, for conveying this information, the emergency can be reported in a quick and time efficient manner. This reduces the amount of time necessary to convey crash relevant information in comparison to a voice call-setup, for example.

Moreover, when the information contained in the emergency message is analyzed, for example in a communication network forwarding the emergency message to a further emergency service node or the like, in such a manner that the information content is considered in the decision regarding the final recipient, a quicker and more suitable response can be provided.

The above and still further objects, features and advantages of the invention will become more apparent upon referring to the description and the accompanying drawings.

### BRIEF DESCRIPTION OF THE DRAWINGS

FIG. 1 shows a signaling diagram illustrating an emergency message transmission according to an example of an embodiment of the invention.

FIG. 2 shows a first example of an emergency message format according to an example of an embodiment of the invention.

FIGS. 3a and 3b show in combination a second example of an emergency message format according to an example of an embodiment of the invention.

FIG. 4 shows a flow chart illustrating a procedure for generating an emergency message for transmitting it from a vehicle towards an emergency service according to an example of an embodiment of the invention.

FIG. 5 shows a block circuit diagram illustrating a configuration of an apparatus for generating an emergency message according to an example of an embodiment of the invention.

FIG. 6 shows a flow chart illustrating a procedure for forwarding an emergency message towards a recipient of an emergency service according to an example of an embodiment of the invention.

FIG. 7 shows a block circuit diagram illustrating a configuration of an apparatus for forwarding an emergency message according to an example of an embodiment of the invention.

FIG. 8 shows a flow chart illustrating a procedure for processing an emergency message transmitted from a vehicle in an emergency service according to an example of an embodiment of the invention.

FIG. 9 shows a block circuit diagram illustrating a configuration of an apparatus for processing an emergency message according to an example of an embodiment of the invention.

### DESCRIPTION OF PREFERRED EMBODIMENTS

In the following, examples and embodiments of the present invention are described with reference to the drawings. For illustrating the present invention, the examples and embodiments will be described in connection with a communication system which may be based on a 3GPP (3^{rd} generation partnership project) architecture where a session initiation protocol (SIP) is used as a transmission protocol between a sending party (such as a movable object like a vehicle or the like) and a receiving party (a communication control element like a proxy or the emergency message recipient). However, it is to be noted that the present invention is not limited to an application in such a system or environment but is also applicable in other communication systems, connection types and the like. For example, the communication system may be based on a WLAN (wireless local area network), WiMAX (Worldwide Interoperability for Microwave Access) or the like, and the transmission protocol may be based, for example, on XMPP (eXtensible Messaging and Presence Protocol), TCP/IP (Transmission Control Protocol/Internet Protocol) or the like, or future transmission protocols not yet developed. It is obvious for the skilled person that depending on the selected communication system and protocol type the elements necessary for implementing the invention may be different to that described in the following with regard to a 3GPP system using SIP.

A basic configuration of a communication system in which an emergency message generation and transmission according to examples of an embodiment of the invention may be implemented may comprise a commonly known architecture of a wired or wireless network. Such an architecture may comprise one or more access network element or control units, radio access network elements, base transceiver stations, communication control elements or servers, proxies and the like, with which a user equipment is capable to communicate via one or more channels for transmitting several types of data. The general functions and interconnections of these elements are known to those skilled in the art and described in corresponding specifications so that a detailed description thereof is omitted herein. However, it is to be noted that there may be provided several additional network elements and signaling links used for a communication connection or a call between terminals and/or servers besides those described in detail herein below.

Furthermore, the network elements and their functions described herein may be implemented by software, e.g. by a computer program product for a computer, or by hardware. In any case, for executing their respective functions, correspondingly used devices, such as a communication control element like a proxy, a movable object like a vehicle, an emergency call or message recipient like a PSAP, comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

According to examples of embodiments of the present invention, there is provided a mechanism which generates and transmits a data-only emergency call for a movable object in case on an emergency. The movable object which generates and sends the emergency message may be, for example, a vehicle like a car, a ship, an airplane or the like. Furthermore, the functions used for generating and sending the emergency message may be comprised in an apparatus or one or more devices installed in the respective movable object, in an apparatus or one or more devices detachably attached to the movable object (for example a mobile telephone, a Personal Data Assistant (PDA), a processing and communication unit (like a computer or a laptop) and the like.

Generally, according to examples of embodiments of the invention, specific information related to the movable object are detected and collected, for example continuously in a time series manner, by means of detecting means like sensors or the like, and stored in a memory at the movable object. For example, the specific information comprises location information or motion information, such as a current position (for example by using a Global Positioning System (GPS), network based positioning systems derived from base station signaling or the like), speed and/or velocity information (for example by using a speed detector of a vehicle), acceleration information (for example by using an acceleration sensor), height information (for example by using a height sensor), orientation information (for example by using a compass) and the like. It is to be noted that the information used as the specific information is not limited to the above examples but may comprise also other information suitable for a respective site of operation (i.e. movable object) in case such information may be useful as additional information in an emergency case.

The collected information may be stored in a memory as a time series of location information. As the measurement of this information would happen continuously and usually the memory space is limited, when the memory space is exhausted, the oldest information may be removed and the actual information may be stored instead.

Alternatively or additionally, the specific information may be further processed in such a manner that an average value of several of the individual information is calculated and stored. For example, an average value of the velocity or the speed may be formed over several time instances and stored as location or motion information in the vehicle.

In addition to the detection for the location information, there are also provided means in the movable object which scan for an occurrence of an emergency. For example, crash sensors detects whether an impact happens indicating an accident or the like, temperature sensors detects for fire, and the like. In case an emergency event is detected (for example a car crash), the generation and transmission of the emergency message is triggered.

For this purpose, the location (motion) information stored in the memory are taken into account and processed. Specifically, for example, a predetermined time interval comprising one or more measurement time points (i.e. data sets stored for a specific measurement time) starting at the most recent data set are used for forming a condition data set in which the respective information are indicated. For example, measurements of the last few seconds may be taken into consideration in case of a car, while in case of a ship or airplane information representing measurements of several minutes may be considered. Alternatively or additionally, the average value of respective information parts may be considered, wherein the calculation of the average value may be done permanently (i.e. before the emergency event happens) or immediately after the detection of the emergency event. Hence, the condition data set may comprise a time series of data and/or an average value. In addition, information indicating the type of the movable object (car, truck, ship etc.) may be added in the condition data set.

The condition data set comprising the location (motion) information may be formed according to an emergency alerting and warning protocol, such as according to the CAP format, and be a part of a corresponding emergency message which is formed according to this format. For example, the standard CAP document format is extended to include this information in addition. Thus, for example, when the emergency event is detected and the generation of the emergency message is triggered, the emergency message is created in accordance with the emergency alerting and warning protocol used, and the condition data set is attached thereto.

It is to be noted that the emergency alerting and warning protocol used in examples of embodiments of the invention is not limited to a specific protocol format, such as CAP. Rather, any protocol format currently existing or developed in the future which may be used as an emergency alerting and warning protocol for providing a template for warning or emergency messages like those generated and processed in examples of embodiments of the invention may be applicable, i.e. a protocol format having, for example, a comparable functionality to CAP. The condition data set may then be attached as a payload to an emergency message generated accordingly, or forwarded in another suitable manner, depending on specifications of the respective protocol format.

Then, an automatic and immediate (i.e. as fast as possible) transmission of the emergency message (comprising the collected information in the condition data set either in the form of the resulting value by averaging the obtained values or the time series of values) is executed by using a predefined transmission procedure. For example, a SIP based transmission to an emergency call recipient is initiated via a SIP based communication network. The transmission comprises the sending of the emergency message which is formed, for example, according to the standardized CAP format wherein information of, for example, speed, velocity, acceleration, or an entire time series thereof is transmitted therewith.

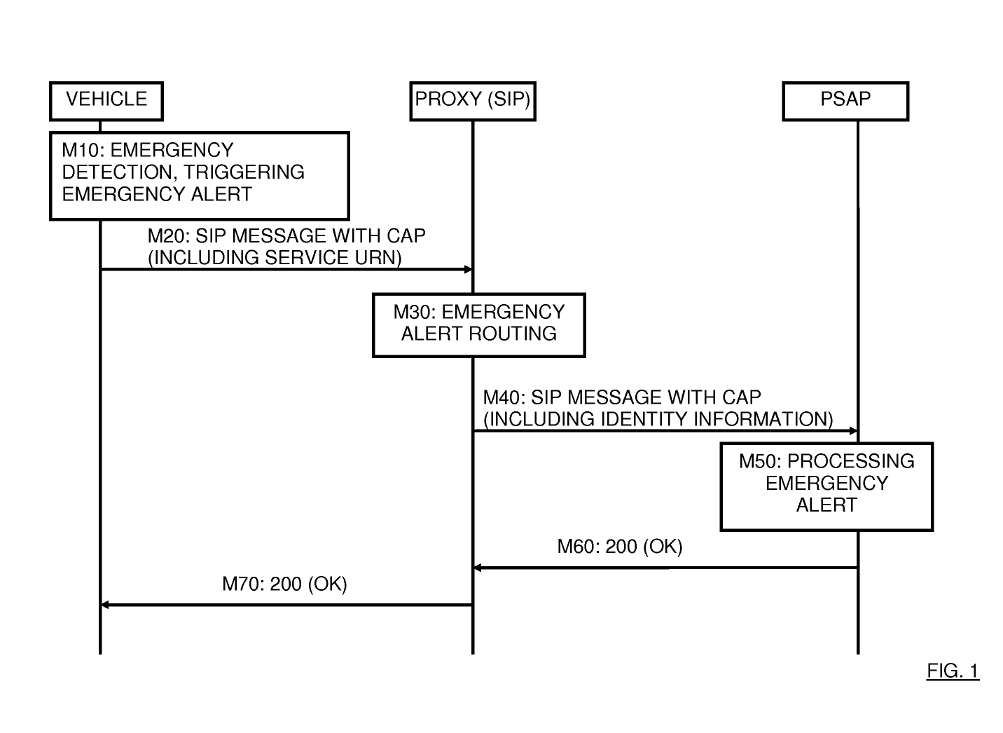

FIG. 1 shows a signalling diagram illustrating a transmission of an emergency message according to an example of an embodiment of the invention. Specifically, FIG. 1 shows the protocol interaction of routing an emergency message through the network towards a recipient, such as a PSAP.

It is to be noted that prior to the signalling indicated in FIG. 1 the sensors in the vehicle (the movable object) collects the above mentioned location (motion) information relevant data and stores them, for example, for a pre-defined period of time (depending on the type of vehicle). Furthermore, the condition data set may be continuously generated (i.e. updated).

According to FIG. 1, in step M10, an emergency event is detected (such as a car crash or the like). As a result, an emergency alert is triggered, i.e. the generation and transmission of the emergency message is initiated.

When the emergency message is generated, for example based on the CAP format, it is transmitted in step S20 towards the emergency service provider via a communication network, such as a 3GPP based network using SIP, for example by using SIP MESSAGE (alternatively, also other mechanisms like SIPO PUBLISH or other SIP messages may be used). The message includes also a resource identifier, such as a service URN (uniform resource name), for example in the form of “urn:service:sos”.

The emergency message travels from the sending movable object (vehicle) to a communication control element of the communication network providing messaging routing functionality, such as a (SIP) proxy. The proxy processed the emergency message in step M30 and determined a destination to which the emergency message is routed. The determination of the destination may be done by using pre-stored or default information (i.e. one or more predefined destination addresses to which an emergency message including the URN is to be routed). Alternatively, the destination, such as a PSAP, may be selected on the basis of a further processing based, for example, on LoST (Location-to-Service-Translation) wherein other elements such as an Emergency Service Routing Proxy (ESRP) may be involved (not shown), which may be a separate element or being part of the SIP proxy. Also the information provided by the emergency message itself may be analyzed for selecting a suitable destination (to be described later).

In step M40, when the destination to which the emergency message is to be routed is determined (i.e., for example, a suitable PSAP), the emergency message with the CAP parts is routed to the determined destination being the emergency call recipient by using SIP MESSAGE. The message in step M40 may further comprise additional identity information, i.e. information regarding a verification of the sender of the emergency message (in order to avoid fault alarms or the like), security information (encryption) and the like. Furthermore, in case the original emergency message from the movable object has not included corresponding information, the SIP proxy may further add the information identifying the movable object (for example, in case there is a contract relation between the network provider and the user of the movable object, data identifying the movable object may be also stored on the network side and has thus not to be necessarily transmitted from the movable object).

In step M50, after receiving the emergency message routed to the selected PSAP, the information in the CAP part (the additional portion comprising the condition data set) is processed so as to derive additional information assisting a call taker (operator, automatic system) for evaluating the received message (i.e. which type of emergency, severity thereof, location and type of involved vehicle, orientation thereof, possible implications by last velocity (history data), and the like). The processing may comprise, for example, a graphical representation on a monitor or the like. Based on this information, the call recipient may dispatch, for example, first responders to the incident scene.

In steps M60 and M70, the receipt of the emergency message may be acknowledged to the sender (the movable object), for example by using SIP 200 OK messages.

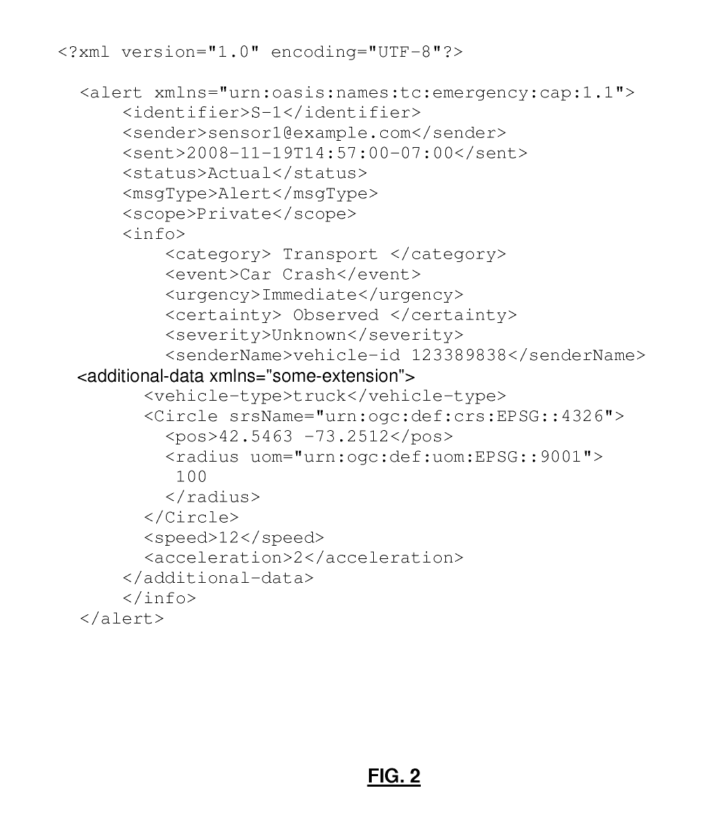

FIG. 2 shows a first example of an emergency alert message generated in accordance with examples of embodiments of the invention. Specifically, FIG. 2 shows an emergency message formed according to the CAP format. The CAP format is specified, for example, in OASIS Standard CAP-V1.1, October 2005.

According to FIG. 2, the emergency message comprises two main parts: a first part which is formed according to the standard rules for CAP, and a second part which is also formed according to the CAP format but contains the condition data set (location, type and motion information). This second part begins at the line <additional-data xmlns=“some-extension”>.

In the first part, information are comprised concerning, for example, the sender (identifier), the sending time, the status (for example actual event, exercise etc.), the message type (e.g. an alert message), the scope (according to examples of embodiments of the invention, the scope is set to “private” since the alert is not used for public information), category information (transport in case of a movable object, for example), event information (for example car crash), urgency information (indicating the urgency of the event and the reaction thereto), certainty information (indicating probability that emergency is true), severity information (how severe is the emergency to be expected), sender-name information (for example a predefined identity code for the sending movable object or apparatus mounted thereon).

In the second part, as indicated above, the location, type and motion related information, for example combined in the condition data set, is located. In the presented example, the condition data set may comprise only one value per data, for example an average value based on several measurements effected before the detection of the emergency event. Thus, there may be information related to the vehicle type (here, a truck), circle and radius information concerning an area in which the vehicle is located, speed information and acceleration information.

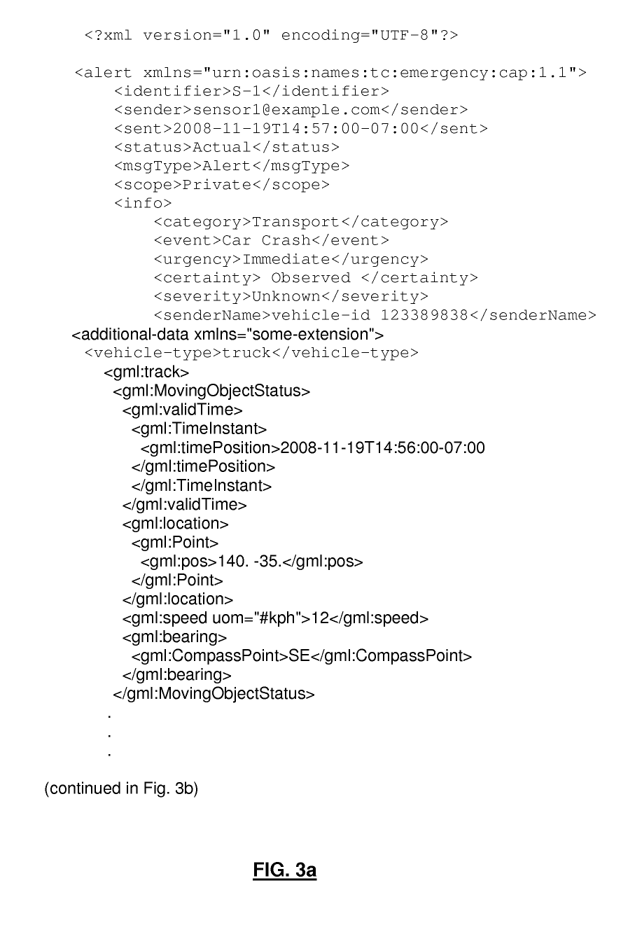

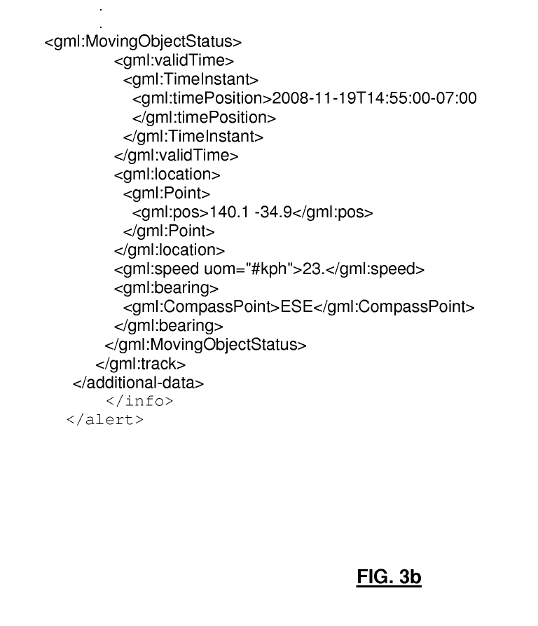

FIGS. 3a and 3b show (in combination) a further example of an emergency alert message generated in accordance with examples of embodiments of the invention. Again, FIGS. 3a and 3b show an emergency message formed according to the CAP format.

Similarly to FIG. 2, according to FIGS. 3a and 3b, the emergency message comprises two main parts: a first part which is formed according to the standard rules for CAP, and a second part which is also formed according to the CAP format but contains the condition data set (location, type and motion information). This second part begins at the line <additional-data xmlns=“some-extension”>.

In contrast to the example of FIG. 2, in FIGS. 3a and 3b an example is presented where time series of measurement data are collected and processed for forming the condition data set.

The first part of the emergency message according to FIG. 3a may be identical to that of FIG. 2 so that a further description thereof is omitted here.

In the second part, as indicated above, the location, type and motion related information, for example combined in the condition data set, is located. In the presented example, the condition data set may comprise information related to the vehicle type (here, a truck) and time series data encompassed in a track portion. Beginning with an indication MovingObjectStatus, a first set of data detected at a first measuring timing (e.g. the most recent measurement) is represented, comprising time data of the measurement, location point information, speed information, orientation information (like a compass direction), and the like. A second set of data detected at a second measuring timing (e.g. the measurement before the most recent measurement) begins with another indication MovingObjectStatus (see FIG. 3b), wherein information corresponding to the first set of data are represented. The number of such data sets (measurement data sets) is not limited to two and can comprise a plurality of sets, depending on system settings, vehicle type, memory space, transmission bandwidth and the like.

As indicated above, according to examples of embodiments of the invention, the emergency message comprises one of the condition data sets illustrated in FIG. 2 or FIGS. 3a, 3b, i.e. with a single parameter set (based, e.g. on averaging) or with time series data. The selection of the respective condition data set type may be preset (for example, the movable object has to send always one of the two types) or done on the basis of further processing. For example, a communication connection between the movable object and the network may be detected with regard to connectivity, available bandwidth or the like in order to determine the reliability of a transmission. On the basis of this detection, it can then be decided whether to send the (shorter) message according to FIG. 2, or the (longer) message according to FIGS. 3a, 3b, for example. Optionally, it may be also possible to send first the short version comprising only the average value based parameters, and to send thereafter the longer version with the time series based parameters (which offers more information), so as to inform the emergency service network as fast as possible.

Furthermore, as indicated above, there may be some security issued in a transmission of (data-only) emergency messages using an emergency alerting and warning protocol like CAP. For illustrating possible measures in this regard, a SIP based communication connection as illustrated in FIG. 1 is used as a basis.

For example, there may be a threat that an adversary could forge or alter a CAP document to report false emergency alarms. To avoid this kind of attack, it has to be ensured that proper mechanisms for protecting the CAP documents are employed, e.g., signing the CAP document itself.

Another threat may be a replay attack where a theft of CAP documents happens and replay of it is done at a later time. For this purpose, a CAP document contains mandatorily identification parts, such as <identifier>, <sender>, <sent> elements, and an optional <expire> element. These attributes make the CAP document unique for a specific sender and provide time restrictions. An entity that has received a CAP message already within the indicated timeframe is able to detect a replayed message and, if the content of that message is unchanged, then no additional security vulnerability is created. Additionally, it is possible to make use of SIP security mechanisms, such as SIP Identity, to tie the CAP message to the SIP message.

Furthermore, it may occur that false alerts are inserted. When an entity receives a CAP message it has to determine whether the entity distributing the CAP messages is genuine to avoid accepting messages that are injected by adversaries. For some types of data-only emergency calls the entity issuing the alert and the entity consuming the alert have a relationship with each other and hence it is possible (using cryptographic authentication) to verify whether a message was indeed issued by an authorized entity. There are, however, other types of data-only emergency calls where there is no such relationship between the sender and the consumer. In that case incoming alerts need to be treated more carefully, as the possibilities to place prank calls are higher than with regular emergency calls that at least setup an audio channel.

In the following, examples of embodiments of the invention describing the procedures and configurations of elements involved in the emergency message generation and transmission mechanism are described.

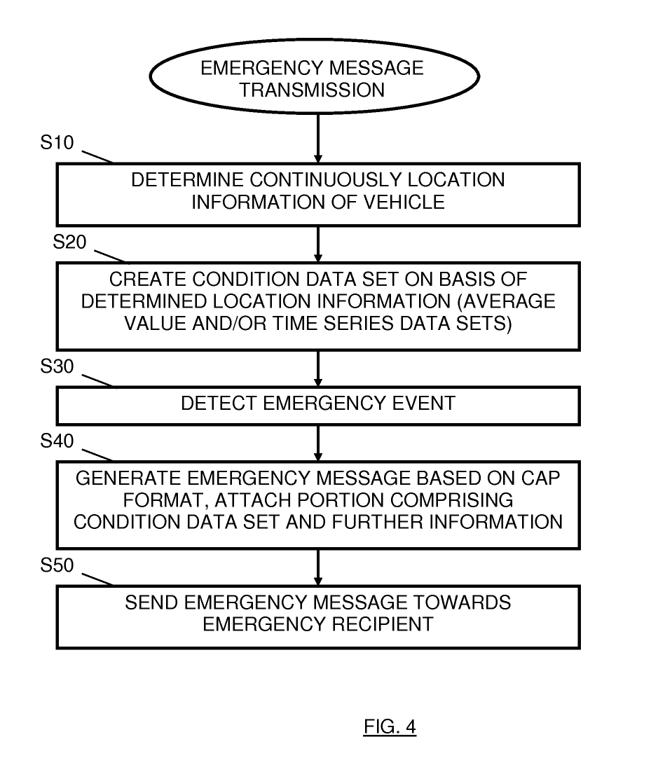

In FIG. 4, a flow chart describing an emergency message generation and transmission procedure according to an example of an embodiment of the invention is shown. The emergency message generation and transmission procedure is executed in the sending entity, i.e. the movable object (vehicle).

Specifically, according to FIG. 4, in step S10, location information (including information concerning the position and motion related information) are determined by sensors or the like in the movable object (e.g. position sensor (GPS), speed sensor, acceleration sensor, height sensor and the like) and stored in a corresponding memory for further processing. The location information may be detected and stored consecutively and continuously a predetermined measurement intervals, for example.

In step S20, the determined location information is processed in order to generate a condition data set to be transmitted in connection with an emergency message. This processing may comprise the generation of an average value, the preparation of consecutive time series data and the like.

In step S20, an emergency event, like a crash or the like, is detected by a corresponding vehicle sensor or the like, triggering the generation of the (final) emergency message and the transmission thereof.

In step S40, the emergency message is created on the basis of a specific emergency alerting and warning protocol, like CAP. For example, a message according to one of FIG. 2 or FIGS. 3a, 3b is generated on the basis of the location information determined in step S10. In addition, further information like a vehicle type may be included. The emergency message may contain thus a portion corresponding to a usual CAP message and a portion comprising the condition data set created in step S20. It is to be noted that the condition data set may also be created not before the emergency event is detected, i.e. directly in combination with step S40.

Then, in step S50, the transmission of the generated emergency message is executed immediately and automatically towards an emergency message recipient, for example a PSAP of an emergency service network, by sending the emergency message comprising for example a service URN as described above to a communication network (i.e. to a routing element like a proxy network element.

As indicated above, steps S40 and S50 may be also repeated in such a manner that another emergency message having more information is sent (such as a message as depicted in FIGS. 3a and 3b) when the first message is in accordance with FIG. 2 (having less information but a higher probability to be correctly received), when for example a connectivity of the movable object (i.e. the communication equipment thereof) to the network is unsure or weak.

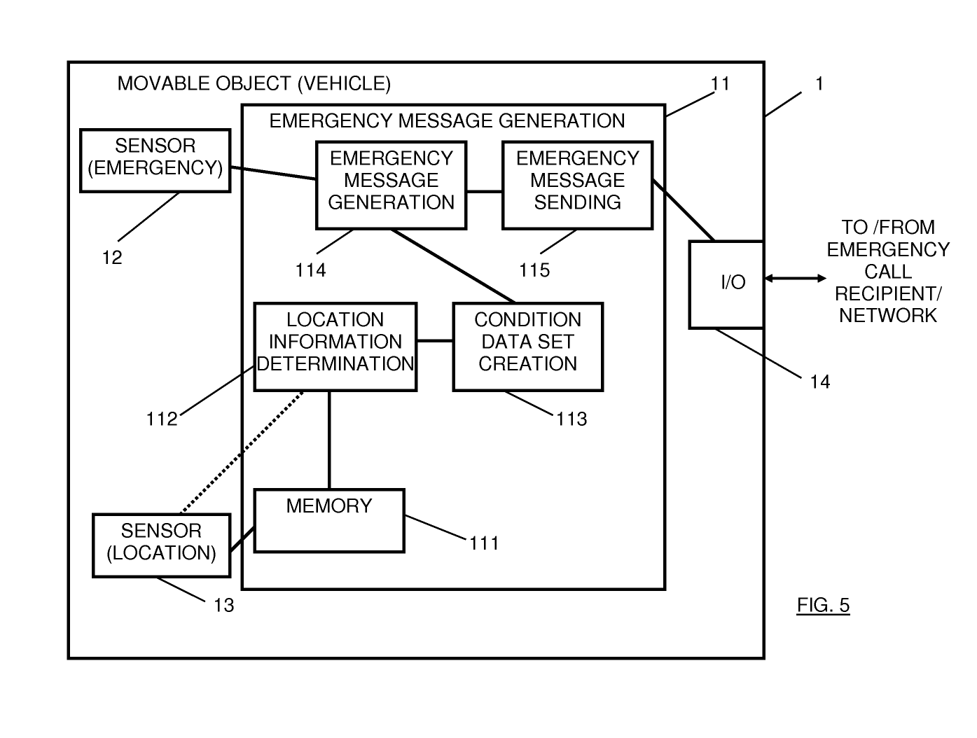

In FIG. 5, block circuit diagrams illustrating a configuration of an apparatus comprised by the movable object (vehicle) capable of executing a procedure for emergency message generation and transmission according to an example of an embodiment of the invention is shown. It is to be noted that the shown apparatus as well as the movable object itself may comprise several further elements or functions besides those described in connection with FIG. 5 which are omitted herein for the sake of simplicity as they are not essential for understanding the invention.

As shown in FIG. 5, the movable object 1 configured to execute the emergency message generation and transmission procedure according to FIG. 4, for example, may comprise a processing function or processor 11, such as a CPU or the like, which executes instructions given by programs or the like related to the emergency message generation and transmission. The processor 11 may comprise further portions dedicated to specific processings described below. However, the portions for executing these specific processings may be also provided as discrete elements or within one or more further processors, for example. Reference sign 12 denotes a sensor (or a plurality of sensors) used for detecting the occurrence of an emergency event. The sensor 12 may comprise, for example, a crash sensor, a temperature or fire sensor, and the like. The sensor 12 is connected to the processor 11 in order to trigger the generation and transmission of the actual emergency message. Reference sign 13 denotes a sensor (or a plurality of sensors) used for detecting location information (vehicle specific information), such as a position sensor, a speed sensor, an acceleration sensor, a height sensor, and the like. The sensor 13 detects continuously and consecutively the location information and sends them to a memory (described later). Reference sign 14 denotes a transceiver or input/output (I/O) unit connected to the processor 11 (or corresponding other elements comprising the functions of the further portions). The I/O unit 14 may be used for communicating with a communication network, i.e. the routing network or proxy element shown in FIG. 1. The I/O unit 14 may also have a distributed structure with a plurality of different interfaces.

Regarding the portions for executing the specific processings related to the emergency message generation and transmission procedure executed by the processor 11, according to examples of embodiments of the invention, reference sign 111 denotes a memory usable, for example, for storing the location information determined by the sensor 13. The memory 111 may be also used for storing further data and programs to be executed by the processor 11 (and/or the further portions dedicated to specific processings) and/or as a working storage of the processor 11 (and/or of the further portions dedicated to specific processings). Reference sign 112 denotes a location information determination portion configured to determine from the memory 111 the required information to be used for creating the condition data set. This may comprise, for example, a reading of a plurality of values for one parameter (like speed) for calculating an average value, or a reading of a plurality of consecutive data from the memory for preparing the time series data set. Reference sign 113 denotes a condition data set creation portion configured to prepare, based on configuration setting (which types and amount of data related to the location information are to be included in the condition data set, and the like) and the determined location information a condition data set to be attached to or included in the emergency message to be sent in case of an emergency event. The condition data set creation portion 113 may be also aware of further data, like vehicle type information, which is also to be included in the portion to be attached to the emergency message. Reference sign 114 denotes an emergency message generation portion which generates, when a trigger signal from the sensor 12 is received, the generation of the (final) emergency message by forming an emergency message on the basis of a preset emergency alerting and warning protocol (e.g. CAP) and attaching a portion comprising the condition data set created in portion 113. Reference sign 115 denotes an emergency message sending portion which initiates sending of the emergency message generated in portion 114 towards a recipient (emergency service system, PSAP) via the I/O unit 14. The apparatus according to FIG. 5 may also comprise a (not-shown) connectivity detector for determining a transmission quality so as to determine which form the emergency message should have (short condition data set or longer condition data set, for example). In addition, the portions 113 and 114 may repeat their operation so as to generate an alternative condition data set and emergency message in case both versions are to be sent one after the other in an emergency event.

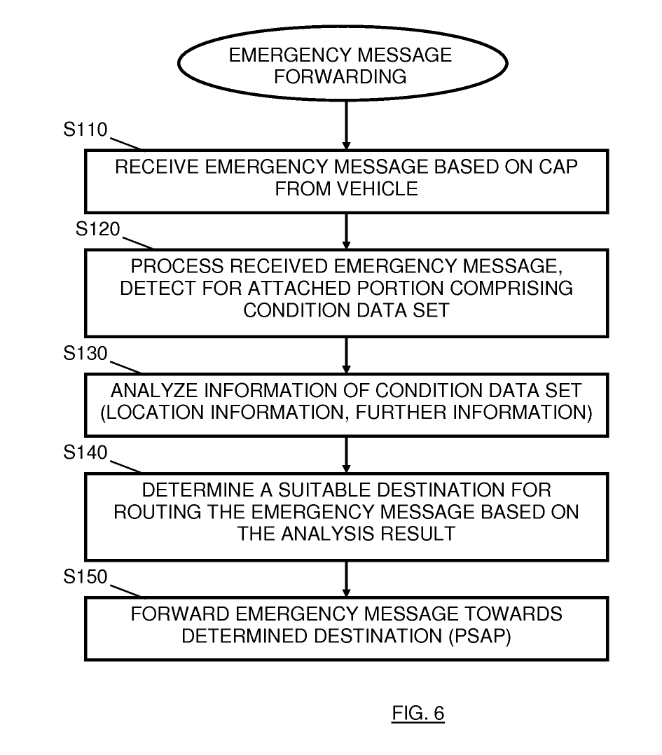

In FIG. 6, a flow chart describing an emergency message forwarding procedure according to an example of an embodiment of the invention is shown. The emergency message forwarding procedure is executed in the network, i.e. proxy element representing the routing network element (e.g. SIP proxy).

In step S110, an emergency message based on CAP, for example (or another emergency alerting and warning protocol) is received from a movable object by using a corresponding transmission protocol, such as SIP. The type of the emergency message may be identified from information in the message, for example, on the basis of the service URN.

In step S120, the received emergency message is processed in order to determine whether it comprises an attached portion comprising a condition data set. This can be executed, for example, by scanning for an indication in the message, such as <additional-data xmlns=“some-extension”>.

After detecting the condition data set, the information contained therein may be analyzed, i.e. the location information and further information like vehicle type. For example, the analysis may comprise a comparison of values included therein (like speed information, location information or the like) or of changings in the information (like sudden height changes) with predetermined values in order to determine background information of the emergency (e.g. a crash at high speed, from a high altitude or the like).

Based on the result of the analysis, a suitable destination for the routing of the emergency message is determined in step S140. For example, in case the analysis results in an assumption that the vehicle sending the emergency message has crashed and dropped from a bridge or the like, a emergency message recipient may be selected which is able to immediately send suitable rescue crew or the like. In other words, step S140 offers a pre-selection for a suitable emergency message recipient (such as a specific PSAP) which can offer the best reaction.

It is to be noted that steps S120 to S140 may be also comprise a simpler processing in which the content of the condition data set is not analyzed as described. For example, the determination of the suitable destination (PSAP) may be done by checking a corresponding entry in the emergency message indicating a traffic accident or the like so that the PSAP in charge thereof is informed. Also a processing according to LoST may be done.

In step S150, the emergency message is forwarded (routed) to the determined destination (for example to the PSAP in charge).

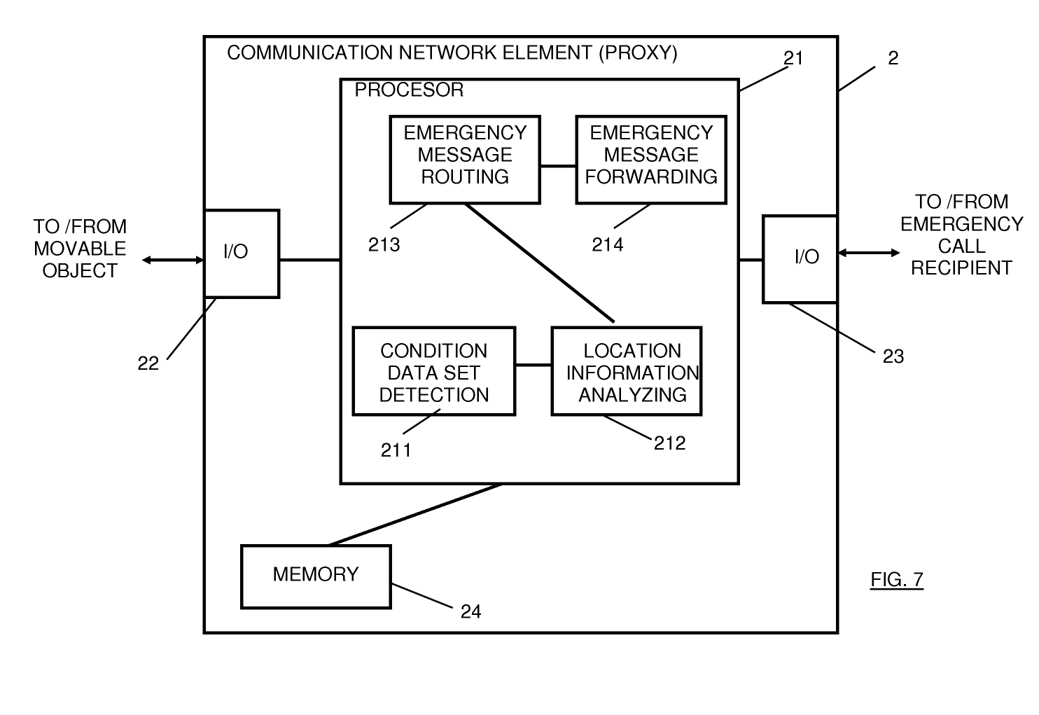

In FIG. 7, a block circuit diagram illustrating a configuration of an apparatus comprised by the communication network routing element (e.g. SIP proxy) capable of executing a procedure for forwarding the emergency message according to an example of an embodiment of the invention is shown. It is to be noted that the shown apparatus or network element may comprise several further elements or functions besides those described in connection with FIG. 7 which are omitted herein for the sake of simplicity as they are not essential for understanding the invention.

As shown in FIG. 7, the communication network element 2 (referred to as proxy hereinafter) configured to execute the emergency message forwarding procedure according to FIG. 6, for example, may comprise a processing function or processor 21, such as a CPU or the like, which executes instructions given by programs or the like related to the emergency message routing. The processor 21 may comprise further portions dedicated to specific processings described below. However, the portions for executing these specific processings may be also provided as discrete elements or within one or more further processors, for example. Reference sign 22 denotes a transceiver or input/output (I/O) unit connected to the processor 21 (or corresponding other elements comprising the functions of the further portions). The I/O unit 22 may be used for communicating with a movable object, i.e. the vehicle shown in FIG. 1. The I/O unit 22 may also have a distributed structure with a plurality of different interfaces. Reference sign 23 denotes a further transceiver or input/output (I/O) unit connected to the processor 21 (or corresponding other elements comprising the functions of the further portions). The I/O unit 23 may be used for communicating with a destination of the emergency message, i.e. the PSAP shown in FIG. 1. The I/O unit 23 may also have a distributed structure with a plurality of different interfaces. Reference sign 24 denotes a memory usable, for example, for storing further data and programs to be executed by the processor 21 (and/or the further portions dedicated to specific processings) and/or as a working storage of the processor 21 (and/or of the further portions dedicated to specific processings).

Regarding the portions for executing the specific processings related to the emergency message forwarding executed by the processor 21, according to examples of embodiments of the invention, reference sign 211 denotes a condition data set detection portion configured to detect a condition data set in the emergency message comprising location information and further information. Reference sign 212 denotes a location information analyzing portion configured to determine location information from the condition data set and to process them for deciding on a suitable routing target. Reference sign 213 denotes an emergency message routing portion configured to select, for example from a set of available address data, a suitable destination, based for example on the analysis result of portion 212. Reference sign 214 denotes an emergency message forwarding portion which initiates sending of the emergency message towards the recipient (emergency service system, PSAP) determined in portion 213 via the I/O unit 23.

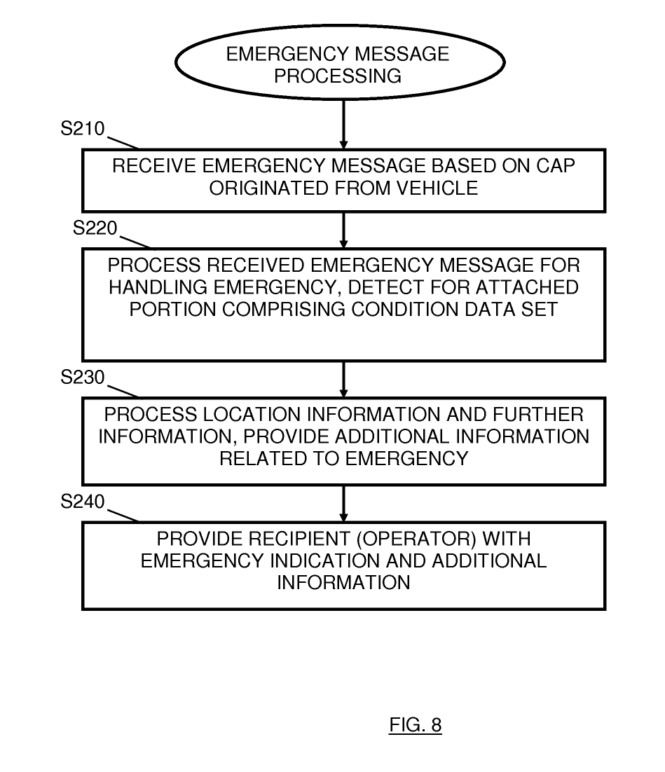

In FIG. 8, a flow chart describing an emergency message processing procedure according to an example of an embodiment of the invention is shown. The emergency message processing procedure is executed in the emergency service system, i.e. the PSAP.

In step S210, an emergency message based on CAP, for example (or another emergency alerting and warning protocol) is received via the communication network from a movable object by using a corresponding transmission protocol, such as SIP.

In step S220, the received emergency message is processed in order to determine the information contained therein. This information comprises both the information comprised in the usual CAP part of the emergency message and in particular the information (location information, motion information, type information etc.) transported by means of the condition data set portion. The discrimination between these two portions can be done, for example, by scanning for an indication in the message, such as <additional-data xmlns=“some-extension”>.

In step S230, after detecting the condition data set, the information contained therein is processed, i.e. the location information and further information like vehicle type are recognized. On the basis of the recognized information, indications or additional information for an operator or an automatic reaction system, which supports the decisions on possible reactions to the emergency call, are calculated or prepared. In step S240, the additional information is provided, together with the usual emergency indication derived from the usual CAP portion, to a recipient. For example, position information may be indicated on a map, information regarding the situation at the emergency site may be provided (e.g. when a high speed accident occurred, probability of personal injuries can be indicated, and the like).

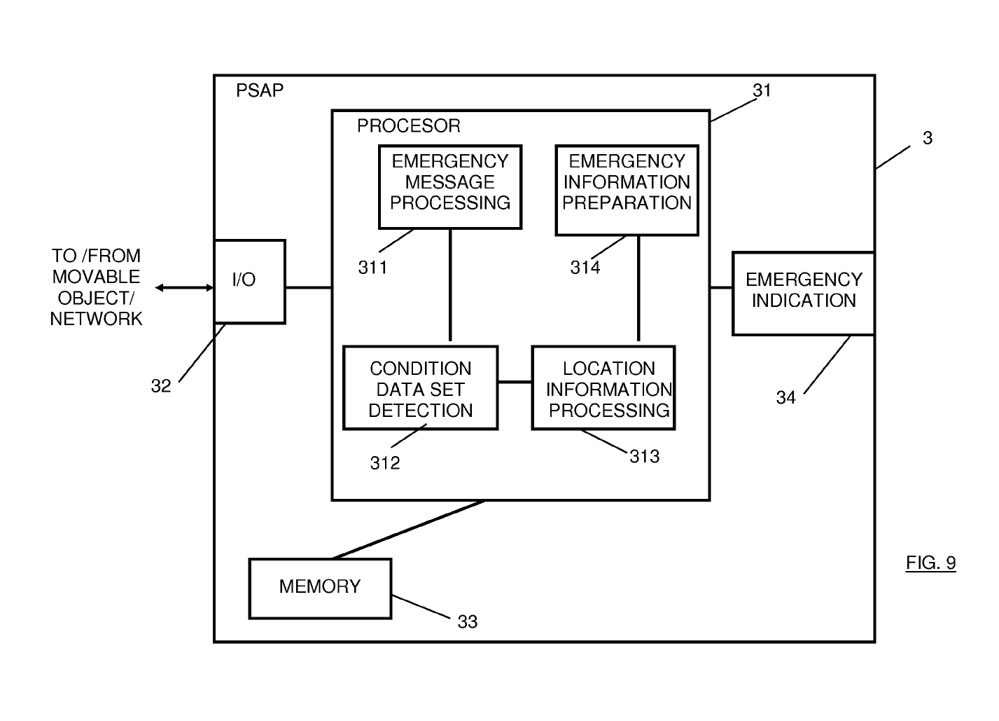

In FIG. 9, a block circuit diagram illustrating a configuration of an apparatus comprised by the emergency service system (e.g. the PSAP) capable of executing a procedure for processing the emergency message according to an example of an embodiment of the invention is shown. It is to be noted that the shown apparatus or network element may comprise several further elements or functions besides those described in connection with FIG. 9 which are omitted herein for the sake of simplicity as they are not essential for understanding the invention.

As shown in FIG. 9, the emergency service system element 3 (referred to as PSAP hereinafter) configured to execute the emergency message processing procedure according to FIG. 8, for example, may comprise a processing function or processor 31, such as a CPU or the like, which executes instructions given by programs or the like related to the emergency message processing. The processor 31 may comprise further portions dedicated to specific processings described below. However, the portions for executing these specific processings may be also provided as discrete elements or within one or more further processors, for example. Reference sign 32 denotes a transceiver or input/output (I/O) unit connected to the processor 21 (or corresponding other elements comprising the functions of the further portions). The I/O unit 32 may be used for communicating with a movable object, i.e. the vehicle shown in FIG. 1, via the communication network, i.e. the proxy shown in FIG. 1. The I/O unit 32 may also have a distributed structure with a plurality of different interfaces. Reference sign 33 denotes a memory usable, for example, for storing further data and programs to be executed by the processor 31 (and/or the further portions dedicated to specific processings) and/or as a working storage of the processor 31 (and/or of the further portions dedicated to specific processings). Reference sign 34 denotes a portion used for providing a recipient, such as an operator or an automatic reaction system, with an indication regarding the presence of an emergency and additional information derived from the condition data set (i.e. location information, motion information, type information and the like).

Regarding the portions for executing the specific processings related to the emergency message forwarding executed by the processor 31, according to examples of embodiments of the invention, reference sign 311 denotes an emergency message processing portion configured to process the complete emergency message received. The processing in portion 311 may comprise the recognition of the presence of an emergency, the emergency type etc. which information may be derived from the common CAP portion of the emergency message, for example. Reference sign 312 denotes a condition data set detection portion configured to detect a condition data set in the emergency message comprising location information and further information. Reference sign 313 denotes a location information processing portion configured to determine location, motion and type information from the condition data set and to process them. Reference sign 314 denotes an emergency information preparation portion configured to determine and select, for example from processing results of portion 313, the additional information to be indicated to the emergency message recipient (such as location of the vehicle, history data and the like). The additional information and the emergency indication are input to the emergency indication portion 34 for notifying the recipient (e.g. an operator) thereabout.

As indicated above, examples of embodiments of the invention are not limited to the usage of CAP as the emergency alerting and warning protocol and/or of SIP as transmission protocol. For example, according to further examples of embodiments of the invention, other types of protocols and formats may be used, such as GeoRSS. GeoRSS may be used for encoding location information wherein Web feeds based on, for example, XML are employed (Web feeds are used to describe feeds or channels of content, such as news articles or text blog entries, which may be rendered by programs such as aggregators and web browsers). As a transport mechanism for such feeds, such as RSS 1.0 feeds, RSS 2.0 feeds, or so-called Atom feeds, HyperText Transfer Protocol (HTTP) may be used, for example. Hence, in the context of examples of embodiments of the invention, the condition data set (i.e. the location information, motion information, type information etc.) may be processed in such a manner that it matches to GeoRSS format (e.g. as a part of the actual message/feed or as an attachment/payload thereof), wherein the transport to the further elements (such as server/proxy of a communication network, the PSAP) may be done by means of HTTP transport mechanism. The basic processing of the emergency message within the elements involved (vehicle, proxy, PSAP etc.) may be similar to that of the examples related to CAP or SIP protocol usage, with corresponding adaptations.

By means of the above described mechanism and processing, it is possible that a call taker is provided with additional information about the incident based on collected information from the vehicle, which supports the decision on further reactions to the emergency call. Specifically, the history data may give additional information about the emergency situation, which e.g. helps evaluating how serious the situation is or what caused the accident, i.e. what happened before the alert. Furthermore, by using emergency messaging to convey this information a time efficient mechanism can be provided.

Examples of embodiments of the invention may be implemented also by means of an apparatus comprising determining means configured to determine location information of a movable object, processing means configured to process the location information for creating a condition data set based on the location information, memory means configured to store the condition data set, message generating means configured to generate an emergency message based on a data format of an emergency alerting and warning protocol, the emergency message comprises a portion including the condition data set, and sending means configured to send the emergency message to a recipient in case an emergency event is detected.

Furthermore, examples of embodiments of the invention may be implemented also by means of an apparatus comprising a receiving means configured to receive an emergency message based on a data format of an emergency alerting and warning protocol from a movable object, processing means configured to process the emergency message, detecting means configured to detect a portion in the emergency message including a condition data set comprising location information, analyzing means configured to analyze the location information, determining means configured to determine a destination for forwarding the emergency message on the basis of the location information, and sending means configured to send the emergency message to the determined destination.

Moreover, examples of embodiments of the invention may be implemented also by means of an apparatus comprising receiving means configured to receive an emergency message based on a data format of an emergency alerting and warning protocol originated from a movable object, first processing means configured to process the emergency message for preparing a reaction thereon, detecting means configured to detect a portion in the emergency message including a condition data set comprising location information, second processing means configured to process the location information contained in the condition data set for providing additional information related to the emergency, and informing means configured to provide a recipient with an indication regarding the emergency together with the additional information based on the location information.

For the purpose of the present invention as described herein above, it should be noted that
an access technology via which signaling is transferred to and from a network element or node, e.g. between a vehicle, a proxy and a PSAP, may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto;
usable access networks including a base transceiver station may be any device, apparatus, unit or means by which a station, entity or other communication equipment included in the movable object may connect to and/or utilize services offered by the access network; such services include, among others, data and/or (audio-) visual communication, data download etc.;
a communication equipment may be any device, apparatus, unit or means by which a system user or subscriber (i.e. movable object) may experience services from an access network, such as a mobile phone, personal digital assistant PDA, a modem card or another computer based equipment;
method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or processing portions likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is proposed a mechanism by means of which an emergency message is generated in a movable object, such as a vehicle, and transmitted to an emergency recipient. Specific information comprising location information of the movable object is determined and processed so as to form an additional information portion for an emergency message based on a data format of an emergency alerting and warning protocol, such as Common Alerting Protocol (CAP). The thus created emergency message is immediately sent to a recipient in case an emergency event is detected. On the recipient side, the location information are retrieved from the emergency message and processed for providing additional information allowing an improved reaction on the emergency.

Although the present invention has been described herein before with reference to particular embodiments thereof, the present invention is not limited thereto and various modifications can be made thereto.

1. A method comprising
determining location information of a movable object,
processing the location information for creating a condition data set based on the location information,
storing the condition data set,
generating an emergency message based on a data format of an emergency alerting and warning protocol, the emergency message comprises a portion including the condition data set, and
sending the emergency message to a recipient in case an emergency event is detected.

2.-10. (canceled)

11. An apparatus comprising
a determiner configured to determine location information of a movable object,
a processor configured to process the location information for creating a condition data set based on the location information,
a memory configured to store the condition data set,
a message generator configured to generate an emergency message based on a data format of an emergency alerting and warning protocol, the emergency message comprises a portion including the condition data set, and
a sender configured to send the emergency message to a recipient in case an emergency event is detected.

12. The apparatus according to claim 11, wherein the location information comprises at least one of position information, velocity information, acceleration information, and orientation information of the movable object at a specific timing.

13. The apparatus according to claim 11, wherein the processor is further configured to include information identifying a type of the movable object in the condition data set.

14. The apparatus according to claim 11, wherein the processor is further configured to calculate, based on the location information, at least one average value of a plurality of location information determined at different timings, wherein the condition data set comprises the calculated at least one average value.

15. The apparatus according to claim 11, wherein the processor is further configured to collect consecutive sets of location information determined at different timings, wherein the condition data set comprises the individual sets of location information determined at different timings, and wherein the processor is further configured to include in the condition data set sets of location information determined within a predefined interval of time, the interval of time starts from the timing the newest set of location information being determined.

16. (canceled)

17. The apparatus according to claim 11, wherein the emergency alerting and warning protocol is based on at least one of
a common alerting protocol, wherein the message generator is further configured to attach the condition data set as a payload to a message portion based on the common alerting protocol format or
a GeoRSS based protocol, wherein the message generator is further configured to attach the condition data set to a message based on GeoRSS format.

18. The apparatus according to claim 11, wherein the sender is configured to send the emergency message to the recipient automatically and immediately when an emergency event of the movable object is detected.

19. (canceled)

20. The apparatus according to claim 11, further comprising
a connectivity checker configured to check a connectivity value of a communication link for sending the emergency message, and
an adjuster configured to adjust the portion including the condition data set of the emergency message on the basis of the connectivity value of the communication link.

21. A method comprising
receiving an emergency message based on a data format of an emergency alerting and warning protocol from a movable object,
processing the emergency message,
detecting a portion in the emergency message including a condition data set comprising location information,
analyzing the location information,
determining a destination for forwarding the emergency message on the basis of the location information, and
sending the emergency message to the determined destination.

22.-26. (canceled)

27. An apparatus comprising
a receiver configured to receive an emergency message based on a data format of an emergency alerting and warning protocol from a movable object,
a processor configured to process the emergency message,
a detector configured to detect a portion in the emergency message including a condition data set comprising location information,
an analyzer configured to analyze the location information, a determiner configured to determine a destination for forwarding the emergency message on the basis of the location information, and
a sender configured to send the emergency message to the determined destination.

28. The apparatus according to claim 27, wherein the location information comprises at least one of position information, velocity information, acceleration information, and orientation information of the movable object at a specific timing.

29. The apparatus according to claim 27, wherein the condition data set comprises information identifying a type of the movable object.

30. The apparatus according to claim 27, wherein the condition data set comprises at least one an average value of a plurality of location information determined at different timings at the movable object, and a collection of consecutive sets of location information determined at different timings at the movable object.

31. The apparatus according to claim 27, wherein the emergency alerting and warning protocol is based on at least one of
a common alerting protocol, wherein the condition data set is attached to the emergency message as a payload to a message portion based on the common alerting protocol format, or
a GeoRSS based protocol, wherein the condition data set is attached to a message based on GeoRSS format.

32. (canceled)

33. A method comprising
receiving an emergency message based on a data format of an emergency alerting and warning protocol originated from a movable object,
processing the emergency message for preparing a reaction thereon,
detecting a portion in the emergency message including a condition data set comprising location information, processing the location information contained in the condition data set for providing additional information related to the emergency, and
providing to a recipient an indication regarding the emergency together with the additional information based on the location information.

34.-38. (canceled)

39. An apparatus comprising
a receiver configured to receive an emergency message based on a data format of an emergency alerting and warning protocol originated from a movable object,
a first processor configured to process the emergency message for preparing a reaction thereon,
a detector configured to detect a portion in the emergency message including a condition data set comprising location information,
a second processor configured to process the location information contained in the condition data set for providing additional information related to the emergency, and
an informer configured to provide a recipient with an indication regarding the emergency together with the additional information based on the location information.

40. The apparatus according to claim 39, wherein the location information comprises at least one of position information, velocity information, acceleration information, and orientation information of the movable object at a specific timing.

41. The apparatus according to claim 39, wherein the condition data set comprises information identifying a type of the movable object, wherein the additional information further comprises a type indication based thereon.

42. The apparatus according to claim 39, wherein the condition data set comprises at least one an average value of a plurality of location information determined at different timings at the movable object, and a collection of consecutive sets of location information determined at different timings at the movable object, wherein the second processor is further configured to include the respective information in the additional information.

43. The apparatus according to claim 39, wherein the emergency alerting and warning protocol is based on at least one of
a common alerting protocol, wherein the condition data set is attached to the emergency message as a payload to a message portion based on the common alerting protocol format, or
a GeoRSS based protocol, wherein the condition data set is attached to a message based on GeoRSS format.

44.-51. (canceled)

52. A computer program product for a computer, comprising software code portions for performing the steps of claim 1, respectively, when said product is run on the computer, wherein said computer program product comprises a computer-readable medium on which said software code portions are stored.

53. (canceled)

54. (canceled)
